(19) United States
(12) Patent Application Publication
(10) Pub. No.: US 2002/0162365 A1
(43) Pub. Date: Nov. 7, 2002

(54) DIALS OF A COMBINATION PADLOCK

(76) Inventor: Chun-Te Yu, Chang-Hwa Hsien (TW)

Correspondence Address: HARRISON & EGBERT, 412 Main Street, 7th Floor, Houston, TX, 77002, US

(21) Appl. No.: 09/847,363

(22) Filed: May 3, 2001

(51) Int. Cl. E05B 37/14

(52) U.S. Cl. 70/25

(57) ABSTRACT

A combination padlock has a lock mechanism, which comprises two dials, with each being mounted on a shaft rod to prevent the two dials from being interfered with each other. The two dials are partially jutted out of the housing of the combination padlock to facilitate the turning of the dials with fingers at the same time.

### BACKGROUND OF THE INVENTION

1. Field of the Invention

The present invention relates generally to a combination padlock, and more particularly to the dials of the combination padlock.

2. Description of Related Art

The conventional combination padlock comprises a plurality of dials, which are mounted at intervals on the same shaft rod. The dials are provided with a plurality of numbers. When the dials are turned to a set series of numbers, the mechanism works to open the padlock.

The conventional combination padlock is defective in design in that the dials are mounted on the same shaft red and are therefore apt to turn at the time when one of the dials is turned. In addition, the set series of numbers of the padlock are not clearly exhibited to prevent confusion.

### BRIEF SUMMARY OF THE INVENTION

The primary objective of the present invention is to provide a combination padlock which is free of the drawbacks of the conventional combination padlock described above.

In keeping with the principle of the present invention, the foregoing primary objective of the present invention is achieved by a combination padlock which is characterized by a lock mechanism comprising two dials, which each being mounted on a shaft rod to prevent the two dials from being interfered with each other. The two dials are partially jutted out of the housing such that the two dials can be turned simultaneously. The combination of numbers of the dials can be easily seen through the windows of the cover of the housing.

The features and advantages of the present invention will be more readily understood upon a thoughtful deliberation of the following detailed description of a preferred embodiment of the present invention with reference to the accompanying drawings.

### BRIEF DESCRIPTION OF THE SEVERAL VIEWS OF THE DRAWINGS

FIG. 1 shows a perspective view of the preferred embodiment of the present invention.

FIG. 2 shows a partial exploded view of the preferred embodiment of the present invention.

FIG. 3 shows a complete exploded view of the preferred embodiment of the present invention.

FIG. 4 shows a schematic plan view of the preferred embodiment of the present invention in combination.

FIG. 5 shows a sectional schematic view of the preferred embodiment of the present invention in combination.

FIG. 6 shows a sectional schematic view of the preferred embodiment of the preferred embodiment of the present invention in action.

FIG. 7 shows a schematic view of the preferred embodiment of the present invention in operation.

FIG. 8 shows another schematic view of the preferred embodiment of the present invention in operation.

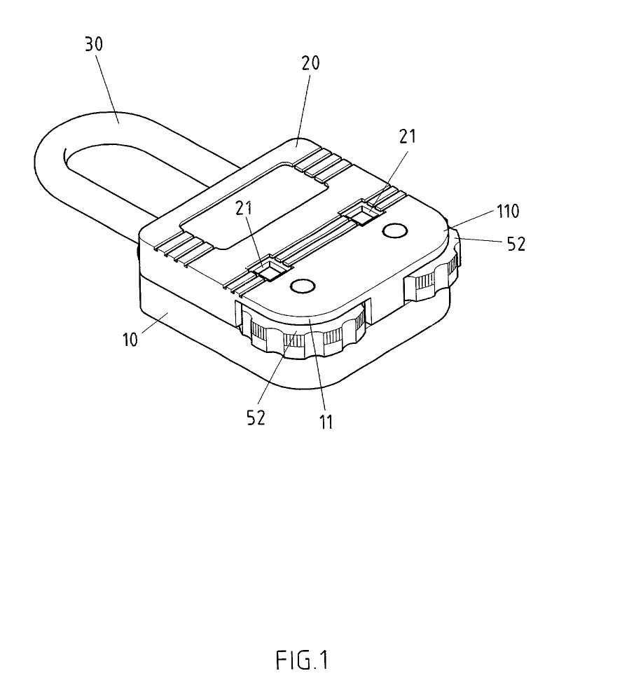

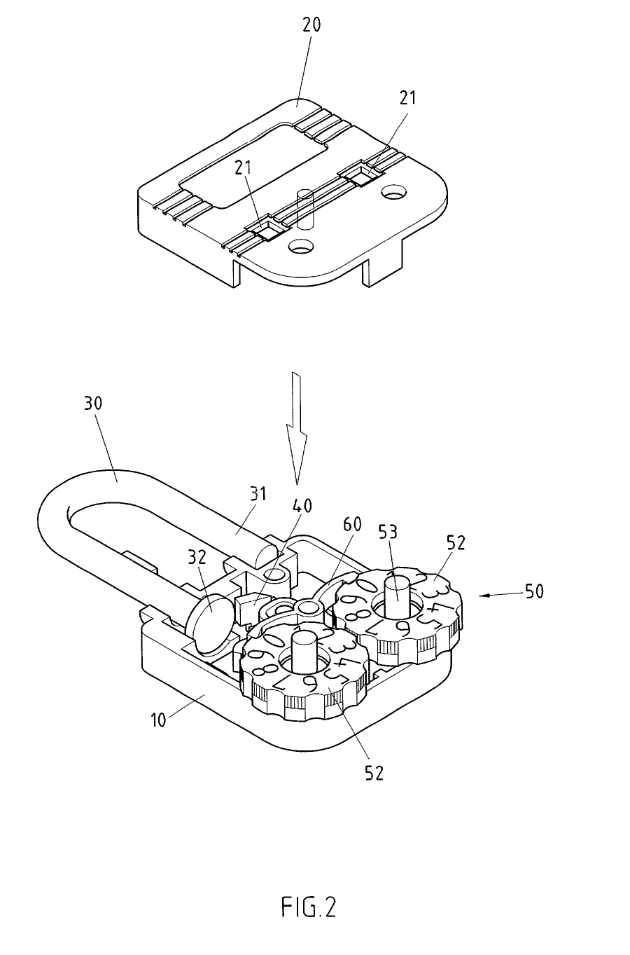

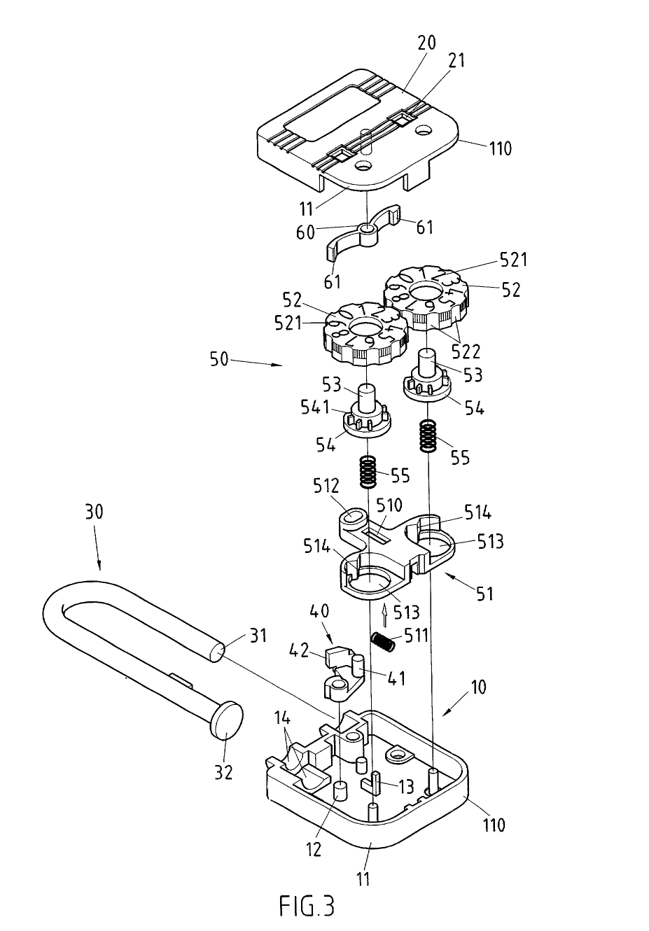

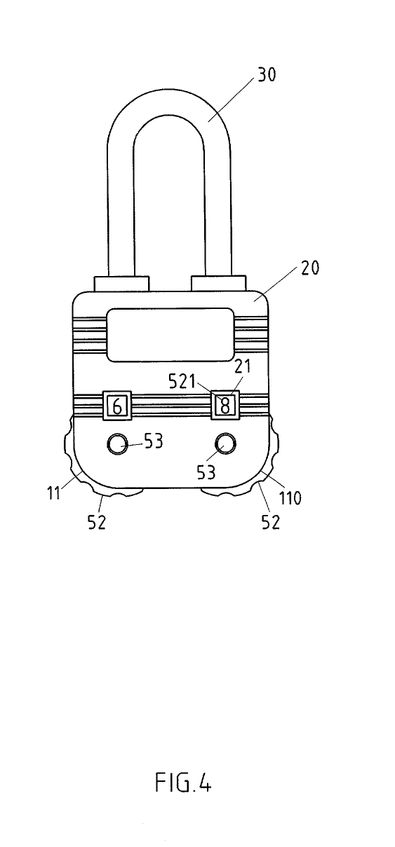

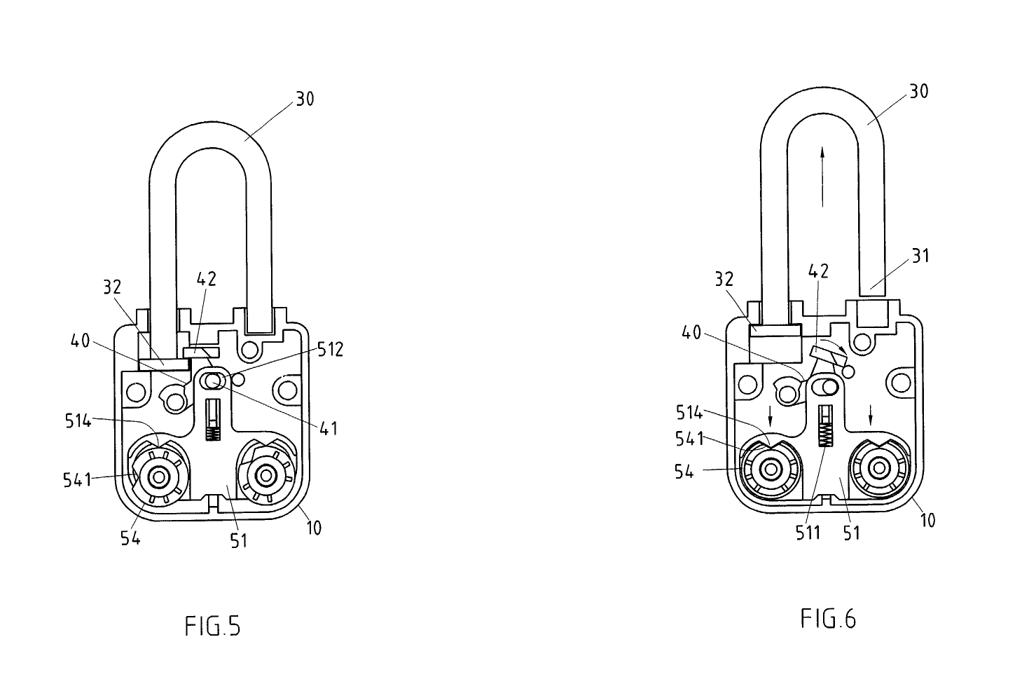

### DETAILED DESCRIPTION OF THE INVENTION

As shown in all drawings provided herewith, a combination padlock of the preferred embodiment of the present invention has a housing which is formed of a base 10 and a cover 20. The cover 20 is provided with two see-through windows 21. The combination padlock of the present invention comprises a shackle 30, a locating member 40, an actuation set 50, and an arresting member 60, which are either fastened with or disposed in the base 10.

The shackle 30 is of a U-shaped construction and is provided at one end with a retaining portion 32, and at other end with a lock end 31. The retaining portion 32 is securely retained in a retaining slot 14 of the base 10.

The locating member 40 is provided with a guide pillar 41 and a stop block 42. The locating member 40 is retained by a retaining pillar 12 of the base 10. When the locating member 40 is turned on the pillar 12 of the base 10, the retaining portion 32 of the shackle 30 is stopped and located by the stop block 42 of the locating member 40.

The actuation set 50 is formed of a position confining seat 51, two dials 52, and two shaft rods 53 on which the two dials 52 are mounted. The position confining seat 51 is movably disposed in the base 10 and is provided with a receiving slot 510 for receiving a projection 13 of the base 10. The position confining seat 51 is provided with two fitting holes 513 for locating the support seats 54 of the two shaft rods 53 in conjunction with two springs 55. The fitting holes 513 are provided with a protruded edge 514, which is received in a recess 541 of the support seats 54. The position confining seat 51 is further provided with a through slot 512 for receiving the guide pillar 41 of the locating member 40. The receiving slot 510 and the projection 13 of the base 10 are urged by a recovery spring 511. The dials 52 are provided in the upper side with numerals 521, and in the rim with a plurality grooves 522 which are arranged at an interval.

The arresting member 60 is provided with two locating tongues 61, which are received in the grooves 522 of the two dials 52 at the time when the dials 52 are turned to a set series of numbers to unlock the padlock.

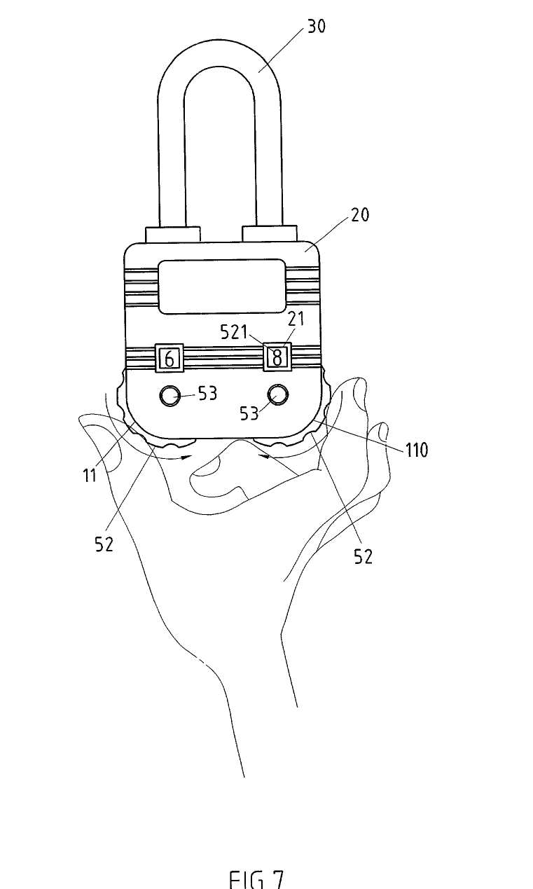

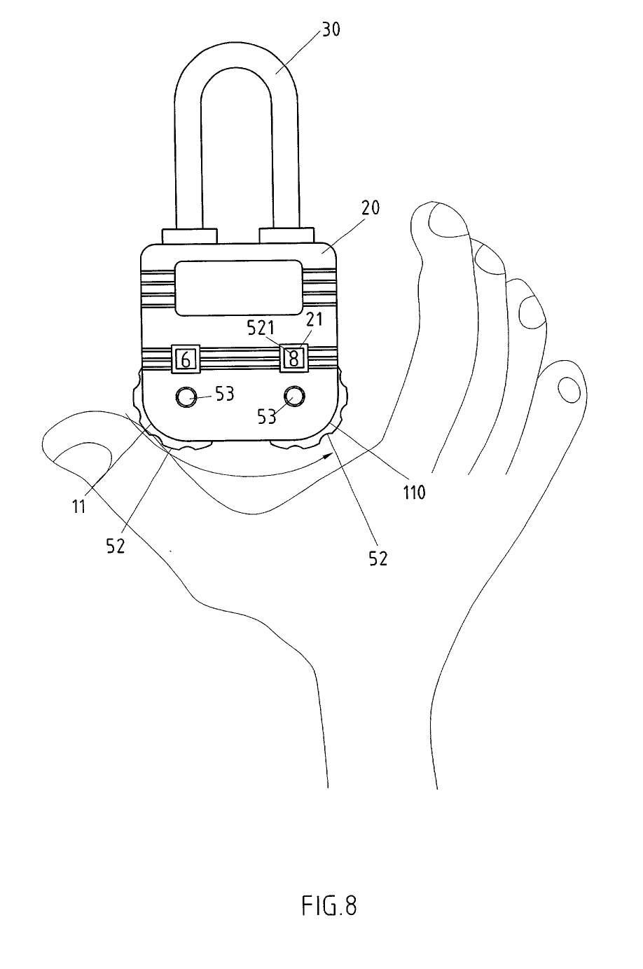

The present invention is characterized by the two dials 52 which are mounted on two shaft rods 53 such that the two dials 52 turn independently. In addition, the numerals 521 of the dials 52 are disposed on the upper surface of the dials 52 such that the numerals 521 can be seen through the see-through windows 21 of the cover 20. The cover 20 is provided in a side wall with two cuts 11 and 110, via which the rims of the two dials 52 are jutted out of the housing of the padlock to facilitate the turning of the two dials 52 with fingers at the same time, as shown in FIG. 7.

The embodiment of the present invention described above is to be regarded in all respects as being merely illustrative and not restrictive. Accordingly, the present invention may be embodied in other specific forms without deviating from the spirit thereof. The present invention is therefore to be limited only by the scope of the following claim.

I claim:

1. A combination padlock comprising:
a housing formed of a base, and a cover provided with two see-through windows;
a shackle of a U-shaped construction and provided at one end with a retaining portion, and at other end with a lock portion, said retaining portion being secured to a retaining slot of said base;
a locating member provided with a guide pillar and a stop block, said locating member being retained by a retaining pillar of said base such that said retaining portion of said shackle is located by said stop block of said locating member at such time when said locating member is turned on said retaining pillar of said base;
an actuation set comprising a position confining seat and two dials confined by said position confining seat in said base, said position confining seat being provided with a receiving slot for receiving a projection of said base, two fitting holes, and a through slot for receiving said guide pillar of said locating member, said two dials being provided with numerals marked thereon such that said numerals are corresponding in location to said see-through windows of said cover, said two dials further provided in the rim with a plurality of grooves which are arranged at an interval; and
an arresting member provided with two locating tongues, which are received in said grooves of said two dials at the time when said two dials are turned;
wherein said cover is provided in a side wall with two cuts contiguous to each other; wherein said actuation seat further comprises two shaft rods supported by two support seats which are located by said two fitting holes of said position confining seat; wherein said two dials are mounted respectively on said two shaft rods such that said two dials turn independently, and that said two dials are partially jutted out of said housing via said two cuts of said cover of said housing.
